(19) United States
(12) Patent Application Publication
(10) Pub. No.: US 2005/0258408 A1
(43) Pub. Date: Nov. 24, 2005

(54) Photochromic contact lenses and methods for their production

(76) Inventors: Frank F. Molock, Orange Park, FL (US); Gina M. Cullerton, Jacksonville, FL (US); Terry L. Spaulding, Jacksonville, FL (US); Shivkumar Mahadevan, Orange Park, FL (US)

Correspondence Address: PHILIP S. JOHNSON;JOHNSON & JOHNSON, ONE JOHNSON & JOHNSON PLAZA, NEW BRUNSWICK, NJ, 08933-7003, US

(21) Appl. No.: 11/102,320

(22) Filed: Apr. 8, 2005

Related U.S. Application Data
(63) Continuation-in-part of application No. 10/027,579, filed on Dec. 20, 2001.

(51) Int. Cl. G02B 5/23

(52) U.S. Cl. 252/586

(57) ABSTRACT

The invention provides a photochromic composition for use in tinting contact lenses in which the binding polymer used is capable of forming an interpenetrating polymer network with the lens material. When the photochromic compositions of the invention are applied to uncured lens material that is subsequently cured, the binding polymer forms an interpenetrating polymer network with the lens material embedding the photochromic compound within the lens material resulting in a stable, photochromic lens.

### RELATED APPLICATIONS

This application is a continuation-in-part of U.S. Ser. No. 10/027,579, which was filed on Dec. 20, 2001.

### FIELD OF THE INVENTION

The invention relates to photochromic tinting compositions useful in the production of photochromic contact lenses. In particular, the invention provides a one step process for photochromically tinting contact lenses and photochromic tinting compositions for use in the process.

### BACKGROUND OF THE INVENTION

Photochromic spectacles have proven to be successful products which afford the wearer the convenience and superior vision and comfort of visible-light absorbing lenses (sunglasses) when exposed to bright light conditions such as daylight, and return to non-absorbing lenses when in low light conditions to provide optimal night and indoor vision, without the need for switching between two pairs of spectacles. Photochromic contact lenses, which would provide wearers superior vision and comfort in bright light conditions such as sunlight, are not currently available.

The use of photochromics to produce a variety of photochromic tinted articles is known. However, existing photochromic compounds and methods for producing very thin photochromic articles, such as contact lenses, have not produced commercially desirable lenses. Prior attempts have either not provided enough darkening to produce a noticeable difference to the wearer, or the existing photochromic compounds and methods for their manufacture were not compatible with the materials and processes used to make ophthalmic devices which reside in or on the eye.

Therefore, a need exists for photochromic compounds, and method for producing contact lenses using the photochromic compounds, that eliminate some or all of these disadvantages.

### DETAILED DESCRIPTION OF THE INVENTION AND PREFERRED EMBODIMENTS

The invention provides photochromic tinting compositions for use in the manufacture of photochromic contact lenses, and a method for the tinting of contact lenses using the photochromic compositions of the invention. In one embodiment, when the photochromic compositions of the invention are applied to uncured lens material that is subsequently cured, the binding polymer forms an interpenetrating polymer network with the lens material. Thus the photochromic composition becomes embedded within the lens material resulting in a stable, photochromic lens. This is advantageous in that the photochromic compositions do not require the use of covalent bonds to aid in the entrapment of the photochromic compound within the lens. Further, the photochromic compositions of the invention transfer from a mold surface to the lens material in a way that results in a finished lens with a high resolution image of the pattern printed using the photochromic composition. Accordingly, the present invention provides improved control over placement of the photochromic compound on the lens.

In one embodiment, the invention provides a photochromic composition for use in tinting contact lenses, the photochromic composition comprising, consisting essentially of, and consisting of one or more photochromic compounds, one or more solvents, and a binding polymer. In one embodiment, the binding polymer is capable of forming an interpenetrating polymer network with a lens material. In another non-limiting embodiment, the invention provides a method for manufacturing a photochromic contact lens comprising, consisting essentially of, and consisting of the steps of: a.) applying to a molding surface of a mold a tinting-effective amount of a photochromic composition, the photochromic composition comprising, consisting essentially of, and consisting of one or more photochromic compounds, one or more solvents and a binding polymer; b.) dispensing a lens-forming amount of a lens material into the mold; c.) swelling the photochromic composition in the lens material and diffusion of the lens material into the photochromic composition; and d.) curing the lens material in the mold under conditions suitable to form the photochromic contact lens, wherein the binding polymer and the lens material form an interpenetrating polymer network. In yet another embodiment, the invention provides a mold for use in manufacturing a tinted contact lens comprising, consisting essentially of, and consisting of a first and second mold half, wherein at least one molding surface of the first and second mold halves comprises, consists essentially of, and consists of: one or more photochromic compounds, one or more solvents, and a binding polymer, wherein the binding polymer is capable of forming an interpenetrating polymer network with a lens material.

For purposes of the invention, “interpenetrating polymer network” or “IPN” is defined as the combination of two or more independent polymers in which one polymer is synthesized and/or cross-linked in the presence of the other. Thus, some degree of interpenetration occurs within the network structures. Typically, the independent polymers used to form the IPN are in network form. One type of IPN, specifically a semi-IPN, is composed of one or more polymers that are cross-linked and one or more polymers that are not substantially cross-linked as disclosed by “Interpenetrating Polymer Networks: An Overview” by Sperling, L. H. in Interpenetrating Polymer Networks, Edited by Klempner, Sperling, and Utracki, pp 3-6(1994). In one embodiment, the type of interpenetrating polymer network used is a semi-IPN. In one embodiment, the semi-IPN is formed using a lens material, which is crosslinked and a binding polymer which is not substantially crosslinked. For the purposes of this invention not substantially crosslinked means that the non-crosslinked material is not subjected to conventional crosslinking conditions prior to contact with the lens material. Semi-IPNs may be formed in one step, or in a series of steps, which are known as sequential semi-IPNs. One of ordinarily skilled in the art will recognize that, the presence of cross-linking agents, either through addition or as impurities, can create a reaction environment that favors the formation of a sequential interpenetrating polymer network.

For purposes of the invention, by “molding surface” is meant a mold surface used to form a surface of a lens.

For purposes of the invention, the term “photochromic” means having an absorption spectrum for at least visible radiation that varies in response to absorption of at least actinic radiation. Further, as used herein, the term “photochromic material” or “photochromic compound” means any substance that is adapted to display photochromic properties, i.e., adapted to have an absorption spectrum for at least visible radiation that varies in response to absorption of at least actinic radiation. Photochromic compounds are well known and several examples are described in “Organic Photochromic and Thermochromic Compounds: Main Photochromic Families (Topics in Applied Chemistry)”, by J. Crano and R. Guglielmetti, published by Plenum Publishing Corporation (Oct. 1, 1998). The photochromic materials can include the following classes of materials: chromenes, e.g., naphthopyrans, benzopyrans, indenonaphthopyrans and phenanthropyrans; spiropyrans, e.g., spiro (benzindoline) naphthopyrans, spiro (indoline) benzopyrans, spiro (indoline) naphthopyrans, spiro (indoline) quinopyrans and spiro (indoline) pyrans; oxazines, e.g., spiro (indoline) naphthoxazines, spiro (indoline) pyridobenzoxazines, spiro (benzindoline) pyridobenzoxazines, spiro (benzindoline) naphthoxazines and spiro (indoline) benzoxazines; mercury dithizonates, fulgides, fulgimides and mixtures of such photochromic compounds. Such photochromic compounds and complementary photochromic compounds are described in U.S. Pat. No. 4,931,220 at column 8, line 52 to column 22, line 40; U.S. Pat. No. 5,645,767 at column 1, line 10 to column 12, line 57; U.S. Pat. No. 5,658,501 at column 1, line 64 to column 13, line 17; U.S. Pat. No. 6,153,126 at column 2, line 18 to column 8, line 60; U.S. Pat. No. 6,296,785 at column 2, line 47 to column 31 line 5; U.S. Pat. No. 6,348,604 at column 3, line 26 to column 17, line 15; and U.S. Pat. No. 6,353,102 at column 1, line 62 to column 11, line 64. Spiro (indoline) pyrans are also described in the text, Techniques in Chemistry, Volume III, “Photochromism”, Chapter 3, Glenn H. Brown, Editor, John Wiley and Sons, Inc., New York, 1971.

In another non-limiting embodiment, other photochromic materials, that can be used include organo-metal dithiozonates, i.e., (arylazo)-thioformic arylhydrazidates, e.g., mercury dithizonates which are described in, for example, U.S. Pat. No. 3,361,706 at column 2, line 27 to column 8, line 43; and fulgides and fulgimides, e.g., the 3-furyl and 3-thienyl fulgides and fulgimides, which are described in U.S. Pat. No. 4,931,220 at column 1, line 39 through column 22, line 41.

In another non-limiting embodiment, polymerizable photochromic materials, such as polymerizable naphthoxazines disclosed in U.S. Pat. No. 5,166,345 at column 3, line 36 to column 14, line 3; polymerizable spirobenzopyrans disclosed in U.S. Pat. No. 5,236,958 at column 1, line 45 to column 6, line 65; polymerizable spirobenzopyrans and spirobenzopyrans disclosed in U.S. Pat. No. 5,252,742 at column 1, line 45 to column 6, line 65; polymerizable fulgides disclosed in U.S. Pat. No. 5,359,085 at column 5, line 25 to column 19, line 55; polymerizable naphthacenediones disclosed in U.S. Pat. No. 5,488,119 at column 1, line 29 to column 7, line 65; polymerizable spirooxazines disclosed in U.S. Pat. No. 5,821,287 at column 3, line 5 to column 11, line 39; polymerizable polyalkoxylated napthopyrans disclosed in U.S. Pat. No. 6,113,814 at column 2, line 23 to column 23, line 29; and the polymerizable photochromic compounds disclosed in WO97/05213 and application Ser. No. 09/828,260 filed Apr. 6, 2001 can be used.

The photochromic materials used in the process of the present invention may be used alone or in combination with one or more other appropriate and complementary photochromic materials, e.g., organic photochromic compounds having at least one activated absorption maxima within the range of 400 and 700 nanometers, and which color when activated to an appropriate hue. Further discussion of neutral colors and ways to describe colors can be found in U.S. Pat. No. 5,645,767, column 12, line 66 to column 13, line 19.

Generally, the ophthalmic devices of the present invention are quite thin, with thicknesses across the optic zone of less than about 300 μm, a frequently less than about 200 μm. Also, the amount of photochromic material which may be incorporated into the ophthalmic device material without degrading the properties of the resulting ophthalmic device, is limited. Accordingly, photochromic materials which display efficient photochromic behavior may be preferred.

An indication of the amount of radiation a material can absorb is the extinction coefficient of the material. The extinction coefficient (“ε”) of a material is related to the absorbance of the material by the following equation:
ε=A/(c×l)
wherein “A” is the absorbance of the material at a particular wavelength, “c” is the concentration of the material in moles per liter (mol/L) and “l” is the path length (or cell thickness) in centimeters (cm). Further, by plotting the extinction coefficient vs. wavelength and integrating over a range of wavelengths (e.g., =∫ε(λ)dλ) it is possible to obtain an “integrated extinction coefficient” for the material. Generally speaking, the higher the integrated extinction coefficient of a material, the more radiation the material will absorb on a per molecule basis. The photochromic materials according to various non-limiting embodiments disclosed herein may have an integrated extinction coefficient greater than 1.0×10⁶ nanometers per (mol×cm) or (nm×mol⁻¹×cm⁻¹) as determined by integration of a plot of extinction coefficient of the is photochromic material vs. wavelength over a range of wavelengths ranging from 320 nm to 420 nm, inclusive. Further, the photochromic materials according to various non-limiting embodiments disclosed herein may have an integrated extinction coefficients of at least 1.1×10⁶ nm×mol⁻¹×cm⁻¹, or at least 1.3×10⁶ nm×mol⁻¹×cm⁻¹ as determined by integration of a plot of extinction coefficient of the photochromic material vs. wavelength over a range of wavelengths ranging from 320 nm to 420 nm, inclusive. For example, according to various non-limiting embodiments, the photochromic material may have an integrated extinction coefficient ranging from 1.1×10⁶ to 4.0×10⁶ nm×mol⁻¹×cm⁻¹ (or greater) as determined by integration of a plot of extinction coefficient of the photochromic material vs. wavelength over a range of wavelengths ranging from 320 nm to 420 nm, inclusive. However, as indicated above, generally speaking the higher the integrated extinction coefficient of a photochromic material, the more radiation the photochromic material will absorb on a per molecule basis. Accordingly, other non-limiting embodiments disclosed herein contemplate photochromic materials having an integrated extinction coefficient greater than 4.0 nm×mol⁻¹×cm⁻¹.

Still other non-limiting embodiments relate to ophthalmic devices comprising photochromic materials comprising: an indeno-fused naphthopyran chosen from an indeno[2′,3′:3,4]naphtho[1,2-b]pyran and an indeno[1′,2′:4,3]naphtho[2,1-b]pyran, wherein the 13-position of the indeno-fused naphthopyran is unsubstituted, mono-substituted or di-substituted, provided that if the 13-position of the indeno-fused naphthopyran is di-substituted, the substituent groups do not together form norbornane; and (ii) a group that extends the pi-conjugated system of the indeno-fused naphthopyran bonded at the 11-position thereof, where said group is a substituted or unsubstituted aryl, a substituted or unsubstituted heteroaryl, or a group represented by —X═Y or —X′≡Y′, wherein X, X′, Y and Y′ are as described herein below and as set forth in the claims; or the group that extends the pi-conjugated system of the indeno-fused naphthopyran together with a group bonded at the 12-position of the indeno-fused naphthopyran or together with a group bonded at the 10-position of the indeno-fused naphthopyran form a fused group, provided the fused group is not a benzo fused group, which are more specifically disclosed in U.S. Ser. No. 11/______, entitled OPHTHALMIC DEVICES COMPRISING PHOTOCHROMIC MATERIALS HAVING EXTENDED PI-CONJUGATED SYSTEMS AND COMPOSITIONS AND ARTICLES INCLUDING THE SAME filed on Apr. 8, 2005, and listing Beon-Kyu, Kim Jun Deng, Wenjing Xiao, Barry Van Gemert, Anu Chopra, Frank Molock and Shivkumar Mahadevan as inventors.

In another non-limiting embodiment the photochromic compounds are naphthopyrans having reactive groups, such as those more specifically disclosed in U.S. Ser. No. 11/______, entitled OPHTHALMIC DEVICES COMPRISING PHOTOCHROMIC MATERIALS WITH REACTIVE SUBSTITUENTS SUBSTITUENTS filed on Apr. 8, 2005, and listing Wenjing Xiao, Barry Van Gemert, Frank Molock and Shivkumar Mahadevan as inventors. Specific non-limiting examples of suitable photochromic compounds are shown in the formula below:

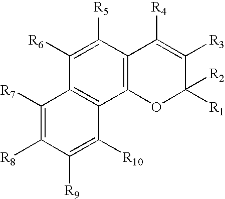

In which R₁, through R₁₀ may comprise H, a monosubstituted alkyl or aryl group, which may optionally comprise a heteroatom such as O, N or S, al alkenyl or alkynyl group, and which may in combination form fused or unfused rings, provided that one or more R group comprises a polymerizable group, such as a methacrylate, acrylate, acrylamide, methacrylamide, fumarate, styryl, N-vinyl amide group, preferably a methacrylate group. Specific non-limiting examples of suitable naphthopyran compounds include those described in:

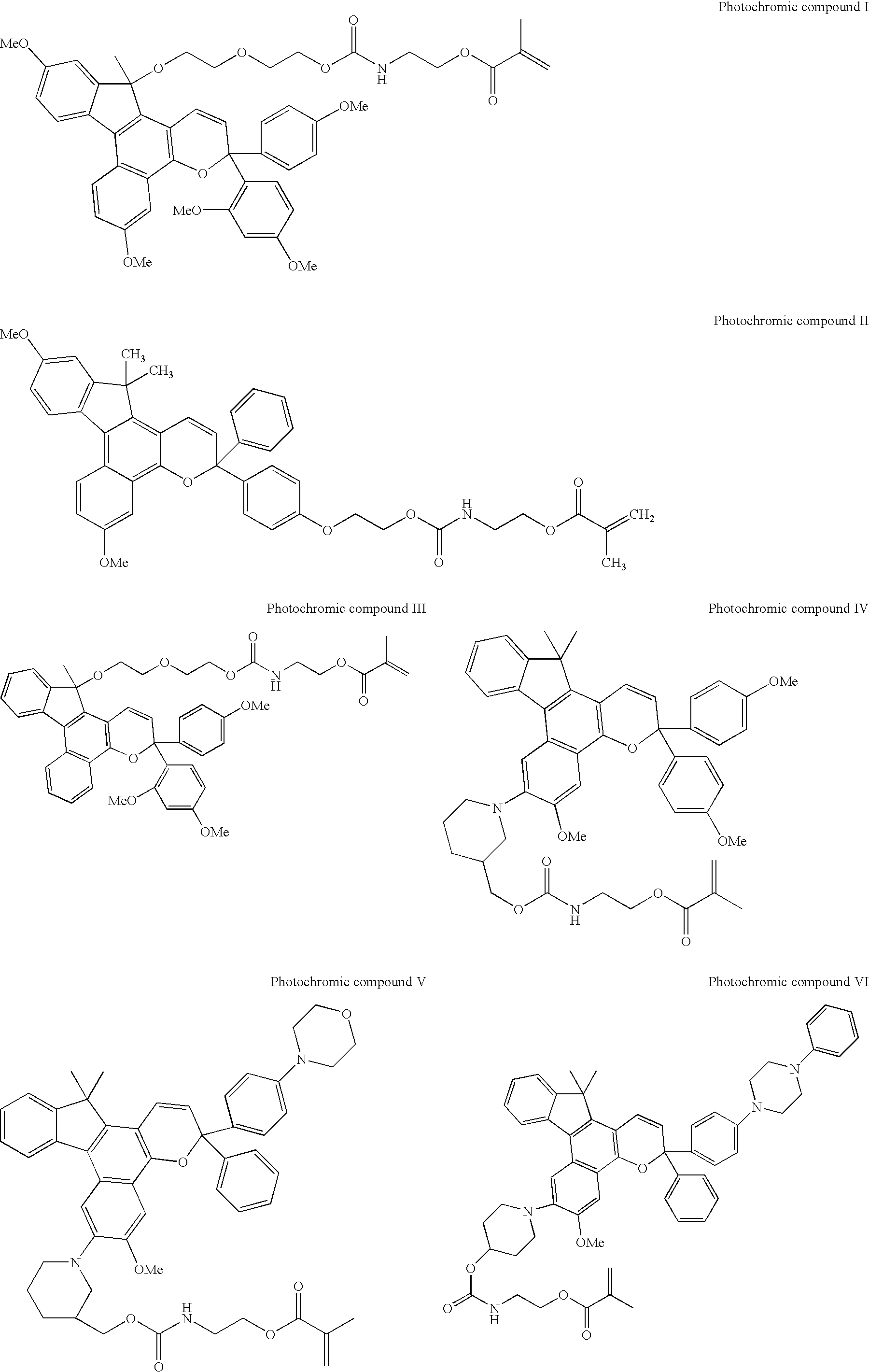

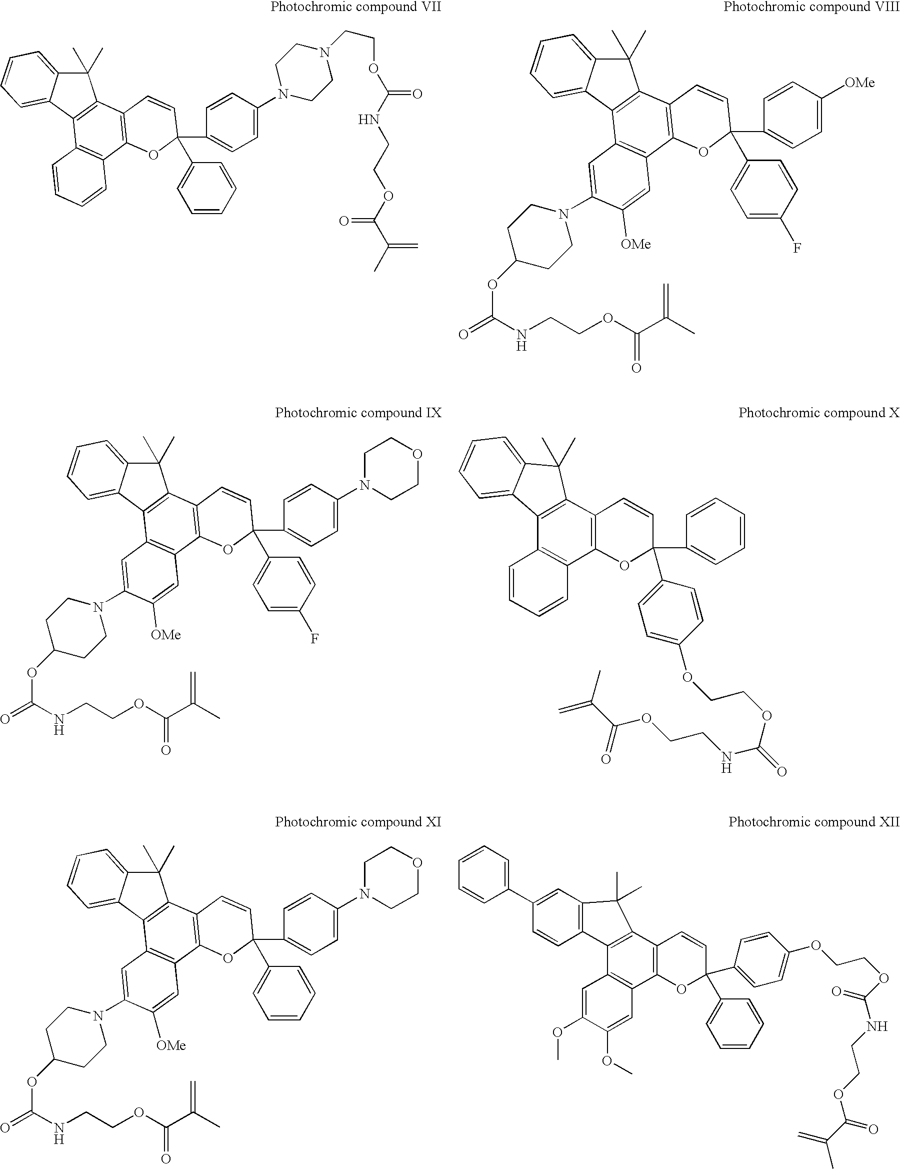

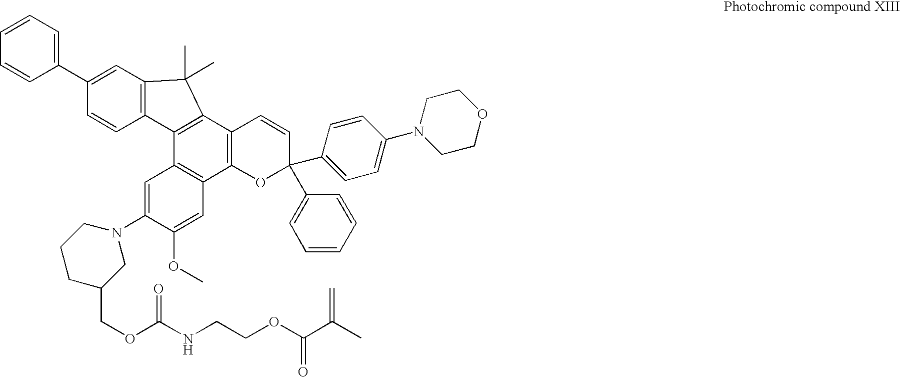

As used herein and in the claims, “photochromic amount” means an amount of photochromic material that is at least sufficient to produce a photochromic effect discernible to the naked eye upon activation. The particular amount used depends often upon the thickness of the lens, the intensity of color desired upon irradiation thereof. Typically, the more photochromic material incorporated, the greater the color intensity is up to a certain limit. There is a point after which the addition of any more material will not have a noticeable effect. The concentration of photochromic compound in the polymerizable mixture is selected based on a number of considerations such as the photochromic efficiency of the photochromic compound, the solubility of the photochromic compound in the polymerizable mixture, the thickness of the lens, and the desired darkness of the lens when exposed to light. Preferred concentrations of the photochromic compound in the photochromic composition are from about 0.1 to about 40 weight %, preferably from about 0.1 to about 30 weight %, more preferably from about 1% to about 20%. The polymerizable mixture may include more than one photochromic compound.

It is a discovery of the invention that by using a binding polymer that is capable of forming an interpenetrating polymer network with a lens material, the need for formation of covalent bonds between the photochromic composition and lens material to form a stable, photochromic lens is eliminated. Stability of the photochromic lens is provided by entrapment of the photochromic compounds within entanglements of the binding polymer and the lens base polymer. The binding polymers of the invention are made from at least one homopolymer, copolymer, or combinations thereof, which are water swellable, capable of forming a stable solution or suspension with the selected photochromic compound(s) and when combined with the other components of the photochromic composition is capable of forming a stable, thin film on a mold surface. As used herein the term stable solution or suspension means a solution wherein the photochromic compound is dissolved in the binding polymer or a suspension wherein the photochromic compound is present as particles having an aveerage particle size of less than about 2 microns which remain suspended without agitation for at least about 30 minutes. As used herein a stable thin film means a film which remains on the part of the lens mold to which it was applied with little retraction or beading. As used herein, water swellable polymers are those that when placed in water, absorb water, but do not dissolve.

In another embodiment, the binding polymer, lens material and materials from which any other coatings are made also have similar solubility parameters. The binding polymers may contain functional groups that render the polymers and copolymers of the binding polymer capable of interactions with each other. The functional groups must be such that the groups of one polymer or copolymer interact with that of another in a manner that increases the density of the interactions helping to inhibit the mobility of and/or entrap the photochromic compound. The interactions between the functional groups may be polar, dispersive, or of a charge transfer complex nature. The functional groups may be located on the polymer or copolymer backbones or be pendant from the backbones.

For example, a monomer, or mixture of monomers, that form a polymer with a positive charge may be used in conjunction with a monomer or monomers that form a polymer with a negative charge to form the binding polymer. As a more specific example, in one embodiment, methacrylic acid (“MAA”) and 2-hydroxyethylmethacrylate (“HEMA”) may be used to provide a MAA/HEMA copolymer that is then mixed with a HEMA/3-(N,N-dimethyl)propyl acrylamide copolymer to form the binding polymer.

As another example and in another embodiment, the binding polymer may be composed of hydrophobically-modified monomers including, without limitation, amides and esters of the formula:
CH₃(CH₂)ₓ-L-COCHR═CH₂
wherein L may be —NH or oxygen, x may be a whole number from 2 to 24, R may be a C₁ to C₆ alkyl or hydrogen and preferably is methyl or hydrogen. Examples of such amides and esters include, without limitation, lauryl methacrylamide, and hexyl methacrylate. As yet another example, polymers of aliphatic chain extended carbamates and ureas may be used to form the binding polymer.

Preferred binding polymers of the invention are a random block copolymer of HEMA, MAA and lauryl methacrylate (“LMA”), a random block copolymer of HEMA and MAA or HEMA and LMA, or a homopolymer of HEMA. The weight percentages, based on the total weight of the binding polymer, of each component in these embodiments is about 93 to about 100 weight percent HEMA, about 0 to about 2 weight percent MAA, and about 0 to about 5 weight percent LMA.

The photochromic composition may further comprise a coating polymer or one or more coating monomers. In embodiments where the ophthalmic device is worn on the surface of the eye, the surface of the contact lens will preferably have a high degree of water wettability and lubricity. Accordingly, for ophthalmic devices worn on the eye, such as contact lenses, it is generally preferred that either the binding polymer comprise components which are either hydrophilic, or can be rendered hydrophilic after the lens is formed, or that a separate coating be applied which comprises components which are either hydrophilic, or can be rendered hydrophilic after the lens is formed. The hydrophilic components may be monomers or polymers so long as they either react into the coating, or are large enough to be entrapped in the cured coating. Examples of hydrophilic polymers that can be used include poly(2-hydroxyethyl methacrylate), poly(ethylene oxide), polyvinylpyrrolidone, poly(N-vinyl-N-methylacetamide), poly(acrylamide), poly(N,N-dimethylacrylamide), polysaccharides, poly(vinylalcohol), copolymers thereof and the like. These hydrophilic polymers can either be functionalized with polymerizable groups, or can be unfunctionalized. In the event that they are unfunctionalized, they may be high enough in molecular weight so that after the lenses are formed they are firmly attached to the lens surfaces by either covalent grafts, or dispersive interactions or entanglement, or some combination of these.

The molecular weight of the binding polymer must be such that it is somewhat soluble in the lens material and swells in it. The lens material diffuses into the binding polymer and is polymerized and/or cross-linked. However, at the same time, the molecular weight of the binding polymer cannot be so high as to impact the quality of the printed image. Preferably, the molecular weight of the binding polymer is about 7,000 to about 100,000, more preferably about 7,000 to about 40,000, most preferably about 17,000 to about 35,000 Mₚₑₐₖ which corresponds to the molecular weight of the highest peak in the SEC analyses (=(Mₙ×M_{w})^{1/2})

For purposes of the invention, the molecular weight is determined using a gel permeation chromatograph with a 90° light scattering and refractive index detectors. Two columns of PW4000 and PW2500, a methanol-water eluent of 75/25 wt/wt adjusted to 50 mM sodium chloride and a mixture of polyethylene glycol and polyethylene oxide molecules with well defined molecular weights ranging from 325,000 to 194 are used.

One ordinarily skilled in the art will recognize that, by using chain transfer agents in the production of the binding polymer, by using large amounts of initiator, by using living polymerization, by selection of appropriate monomer and initiator concentrations, by selection of amounts and types of solvent, or combinations thereof, the desired binding polymer molecular weight may be obtained. Preferably, a chain transfer agent is used in conjunction with an initiator, or more preferably with an initiator and one or more solvents to achieve the desired molecular weight. Alternatively, small amounts of very high molecular weight binding polymer may be used in conjunction with large amounts of solvent to maintain a desired viscosity for the binding polymer. Preferably, the viscosity of the binding polymer will be about 4,000 to about 15,000 centipoise at 23° C.

Chain transfer agents useful in forming the binding polymers used in the invention have chain transfer constants values of greater than about 0.01, preferably greater than about 7, and more preferably greater than about 25,000. Suitable such chain transfer agents are known and include, without limitation, aliphatic thiols of the formula R—SH wherein R is a C₁ to C₁₂ aliphatic, a benzyl, a cyclicalipahtic or CH₃(CH₂)ₓ—SH wherein x is 1 to 24, benzene, n-butyl chloride, t-butyl chloride, n-butyl bromide, 2-mercapto ethanol, 1-dodecyl mercaptan, 2-chlorobutane, acetone, acetic acid, chloroform, butyl amine, triethylamine, di-n-butyl sulfide and disulfide, carbon tetrachloride and bromide, and the like, and combinations thereof. Generally, about 0 to about 7 weight percent based on the total weight of polymer formulation will be used. Preferably dodecanethiol, decanethiol, octanethiol, or combinations thereof is used as the chain transfer agent.

One or more initiator(s) may also be used in the production of the binding polymers used in this invention. Any desirable initiators may be used including, without limitation, ultra-violet, visible light, thermal initiators and the like and combinations thereof. In one embodiment, a thermal initiator is used. Thermal initiators useful in this invention include compounds that generate free radicals at moderately elevated temperatures. Suitable classes of thermal initiators include, but are not limited to thermally labile azo compounds and peroxides. Non-limiting examples of thermally labile azo compounds include, but are not limited to, 2,2′-azobisisobutyronirile, 2,2′-azobis-2-methylbutyronitrile, 2,2′-azobis-2-methylvaleronitrile, 2,2′-azobis-2,3-dimethylbutyronitrile, 2,2′-azobis-2-methylhexanenitrile, 2,2′-azobis-2,4-dimethylvaleronitrile, 2,2′-azobis-2,3,3-trimethylbutyronitrile, 2,2′-azobis-2-methylheptanenitrile, 2,2′-azobis-2-cyclopropylpropionitrile, 2,2′-azobis-2-cyclopentylpropionitrile, 2,2′-azobis-2-benzylpropionitrile, 2,2′-azobis-2-(4-nitrobenzyl)propionitrile, 2,2′-azobis-2-cyclobutylpropionitrile, 2,2′-azobis-2-cyclohexylpropionitrile, 2,2′-azobis-2-(4-chlorobenzyl)propionitrile, 2, 2′-azobis-2-ethyl-3-methylvaleronitrile, 2,2′-azobis-2-isopropyl-3-methylvaleronitrile, 2,2′-azobis-2-isobutyl-4-methylvaleronitrile, 1,1′-azobis-1-cyclohexanenitrile, 1,1′-azobis-1-cyclobutanenitrile, 2,2′-azobis-2-carbomethoxypropionitrile, 2,2′-azobis-2-carboethoxypropionitrile, and combinations thereof and the like. Non-limiting examples of peroxides include, but are not limited to; cumene hydroperoxide, methyl ethyl ketone peroxide, cyclohexanone peroxide, bis-(1-oxycyclohexyl)peroxide, acetyl peroxide, capryl peroxide, lauroyl peroxide, stearoyl peroxide, benzoyl peroxide, p,p′-dichloro-benzoyl peroxide, (2,4,2′,4′-tetrachloro)-benzoyl peroxide, di-t-butyl peroxide, di-t-amyl peroxide, t-butyl-cumyl peroxide, dicumyl peroxide, 2,5-dimethyl-2,5-di(t-butyl peroxide)-hexane, t-butyl hydroperoxide, p-menthane hydroperoxide, 2,5-dimethyl-2,5-dihydroperoxide-hexane, t-butyl peracetate, t-butyl perisobutyrate, t-butyl perpivalate, t-butyl perbenzoate, di-t-butyl perphthalate, 2,5-dimethyl(2,5-benzoylperoxy)-hexane, t-butyl permaleate, i-propyl percarbonate, t-butylperoxy-i-propyl carbonate, succinic acid peroxide and combinations thereof and the like. In one embodiment, preferred initiator combinations include at least one thermal initiator selected from include lauryl peroxide, benzoyl peroxide, isopropyl percarbonate, azobisisobutyronitrile, mixtures thereof and the like. In another embodiment, the initiator comprises 2,2-azobis isobutyronitrile, 2,2-azobis 2-methylbutyronitrile, or combinations thereof. Suitable amounts of thermal initiator include about 0.1 to about 5 weight percent based on the total weight of the photochromic composition. In one embodiment, 2,2-azobis 2-methylbutyronitrile is used with dodecanethiol. Combinations of thermal and photoinitiators may also be used.

Generally suitable photoinitiators will absorb light in the range from 200 nm to about 700 nm. Depending on the absorbance spectra of the photochromic compound selected, suitable photoinitiators will absorb light in the range of about 200 to about 300 nm or about 400 to about 700 nm. Photoinitiators useful in this invention include aromatic alpha-hydroxy ketones, alkoxyoxybenzoins, acetophenones, acyl phosphine oxides, and a tertiary amine plus a diketone, mixtures thereof and the like. Illustrative examples of suitable photoinitiators are 1-hydroxycyclohexyl phenyl ketone, 2-hydroxy-2-methyl-1-phenyl-propan-1-one, bis(2,6-dimethoxybenzoyl)-2,4-4-trimethylpentyl phosphine oxide (DMBAPO), bis(2,4,6-trimethylbenzoyl)-phenylphosphineoxide (Irgacure 819), 2,4,6-trimethylbenzyldiphenyl phosphine oxide and 2,4,6-trimethylbenzyoyl diphenylphosphine oxide, benzoin methyl ester and a combination of camphorquinone and ethyl 4-(N,N-dimethylamino)benzoate, mixtures thereof and the like. Commercially available visible light initiator systems include Irgacure® 819, Irgacure 1700, Irgacure® 1800, Irgacure® 819, Irgacure® 1850 (all from Ciba Specialty Chemicals) and Lucirin® TPO initiator (available from BASF). Commercially available UV photoinitiators include Darocur® 1173 and Darocur® 2959 (Ciba Specialty Chemicals).

Suitable cure intensities include between about 0.1 mW/cm² to about 10 mW/cm² and preferably between about 0.2 mW/cm² and 6 mW/cm², and more preferably between about 0.2 mW/cm² and 4 mW/cm². Suitable times for photocuring include from about 0.5 to about 30 minutes, preferably from about 1 minute to about 20 minutes.

Exemplary combinations include acyl phospine oxides and azobisisobutyronitrile. In one embodiment the thermal initiator comprises azobisisobutyronitrile and the photoinitiator is selected from bis(2,4,6-trimethylbenzoyl)-phenyl phosphine oxide, bis(2,6-dimethoxybenzoyl)-2,4-4-trimethylpentyl phosphine oxide, 2,4,6-trimethylbenzyldiphenyl phosphine oxide and 2,4,6-trimethylbenzyoyl diphenylphosphine oxide, and mixtures thereof. In another embodiment the thermal initiator comprises azobisisobutyronitrile and the photoinitiator comprises bis(2,4,6-trimethylbenzoyl)-phenyl phosphine oxide.

If a photoinitiator is used, suitable amounts of photoinitiator to be added to the photochromic composition range from about 0.1 to about 5 weight %, preferably about 0.3 to about 3 weight %, and more preferably from about 0.3 to about 2 weight %. The precise amount of each initiator depends on the molar efficiency of each and on the temperature and the source and intensity of the light used to cure the lenses.

The photochromic compositions of the invention may be made by any convenient polymerization process including, without limitation, radical chain polymerization, step polymerization, emulsion polymerization, ionic chain polymerization, ring opening, group transfer polymerization, atom transfer polymerization, and the like. Preferably, a thermal-initiated, free-radical polymerization is used. Conditions for carrying out the polymerization are within the knowledge of one ordinarily skilled in the art.

Solvents useful in the production of the photochromic composition are medium boiling solvents having boiling points between about 120 and 230° C. Selection of the solvent to be used will be based on the type of binding polymer to be included and its molecular weight. Suitable solvents include, without limitation, diacetone alcohol, cyclohexanone, isopropyl lactate, 3-methoxy 1-butanol, 1-ethoxy-2-propanol, and the like.

The binding polymer of the invention is tailored, in terms of expansion factor in water, to the lens material with which it will be used. Matching or substantially matching the expansion factor of the binding polymer with that of the cured lens material in packing solution avoids the development of stresses within the lens that result in bad optics and lens parameter shifts. Additionally, the binding polymer must be swellable in the lens material, permitting swelling of the image printed using the photochromic tinting composition of the invention. Due to this swelling, the image becomes entrapped within the lens material without any impact on lens comfort.

The binding polymer may also include one or more pigments or dyes. The pigments or dyes may be included to provide the lens with a desired color, neutral hue or additional cosmetic effects or patterns. Illustrative organic pigments include, without limitation, pthalocyanine blue, pthalocyanine green, carbazole violet, vat orange # 1, and the like and combinations thereof. Examples of useful inorganic pigments include, without limitation, iron oxide black, iron oxide brown, iron oxide yellow, iron oxide red, titanium dioxide, and the like, and combinations thereof. In addition to these pigments, soluble and non-soluble dyes may be used including, without limitation, dichlorotriazine and vinyl sulfone-based dyes. Useful dyes and pigments are commercially available.

Coating, or wetting, of the photochromic compounds with binding polymer provides better dispersion in the binding polymer of photochromic compounds which are not soluble in the binding polymer. The coating may be achieved by use of electrostatic, dispersive, or hydrogen bonding forces to cover the photochromic compound's surface. Preferably, a high shear force is used to disperse the photochromic compounds into the binding polymer. The photochromic compounds may be added to the binding polymer by dispensing the polymer and photochromic compounds into a suitable mixer, such as a rotary shaft mixer and mixing until a homogeneous mixture results, typically for a period of up to about 30 minutes. The mixture may be then fed into a high shear mill, such as an Eiger mill to disperse the photochromic compounds into the binding polymer. Repeated milling is carried out as necessary to achieve complete dispersion. Generally, for photochromic compounds which are not soluble in the binding polymer, milling is carried out until the photochromic compounds are about 0.2 to about 3 microns in size. Milling may be carried out using any suitable, commercially available device including, without limitation, a high shear or ball milling device.

In addition to the photochromic compounds and binding polymer, the photochromic tinting composition of the invention contains one or more solvents that aid in coating of the photochromic tinting composition onto a surface. It is another discovery of the invention that, to ensure the photochromic composition does not bleed or run on the surface to which it is applied, it is desirable, and preferred, that the photochromic composition have a surface tension below about 27 mN/m. This surface tension may be achieved by treatment of the surface, for example a mold surface, to which the photochromic tinting composition will be applied. Surface treatments may be effected by methods known in the art, such as, but not limited to plasma and corona treatments. Alternatively, and preferably, the desired surface tension may be achieved by the choice of solvents used in the photochromic composition.

Thus, the solvents useful in the photochromic composition of the invention are those solvents that are capable of increasing or decreasing the viscosity of the photochromic composition and aiding in controlling the surface tension. Suitable solvents include, without limitation, cyclopentanones, 4-methyl-2-pentanone, 1-methoxy-2-propanol, 1-ethoxy-2-propanol, isopropyl lactate and the like and combinations thereof. Preferably, 1-ethoxy-2-propanol and isopropyl lactate are used.

In a preferred embodiment, at least three different solvents are used in the photochromic composition of the invention. The first two of these solvents, both medium boiling point solvents, are used in the production of the binding polymer. Although these solvents may be stripped from the binding polymer after its formation, it is preferred that they are retained. Preferably, the two solvents are 1-ethoxy-2-propanol and isopropyl lactate. An additional low boiling solvent, meaning a solvent the boiling point of which is between about 75 and about 120° C., is used to decrease the viscosity of the photochromic composition as desired. Suitable low boiling solvents include, without limitation, 2-propanol, 1-methoxy-2-propanol, 1-propanol, and the like and combinations thereof. Preferably, 1-propanol is used.

The specific amount of solvents used will depend on a number of factors. For example, the amount of solvents used in forming the binding polymer will depend upon the molecular weight of the binding polymer desired and the constituents, such as the monomers and copolymers, used in the binding polymer. The amount of low boiling solvent used will depend upon the viscosity and surface tension desired for the photochromic composition. Further, if the photochromic composition is to be applied to a mold and cured with a lens material, the amount of solvent used will depend upon the lens and mold materials used and whether the mold material has undergone any surface treatment to increase its wettability. Determination of the precise amount of solvent to be used is within the skill of one ordinarily skilled in the art. Generally, the total weight of the solvents used will be about 40 to about 75 weight percent of solvent will be used.

In addition to the solvents, a plasticizer may be and, preferably is, added to the photochromic composition to reduce cracking during the drying of the photochromic composition and optical mold parts, to enhance the final quality of the image produced using the photochromic composition, and to enhance the diffusion and swelling of the photochromic composition by the lens material. The type and amount of plasticizer used will depend on the molecular weight of the binding polymer used and, for photochromic compositions placed onto molds that are stored prior to use, the shelf-life stability desired. Useful plasticizers include, without limitation, glycerol, propylene glycol, dipropylene glycol, tripropylene glycol, polyethylene glycol 200, 400, or 600, and the like and combinations thereof. Preferably, glycerol is used. Amounts of plasticizer used generally will be 0 to about 10 weight percent based on the weight of the photochromic composition.

In a preferred photochromic tinting composition mixture of the invention, about 0.2 to about 25 weight percent of photochromic compound, about 30 to about 45 weight percent of binding polymer, about 40 to about 70 weight percent of solvents, about 0 to about 25 weight percent of conventional pigments and dyes, and about 0.2 to about 7 weight percent of plasticizer is used. The weight percentages are based on the total weight of the photochromic composition mixture.

One ordinarily skilled in the art will recognize that additives other than those discussed also may be included in the photochromic composition of the invention. Suitable additives include, without limitation, additives that aid flow and leveling, additives for foam prevention, additives for rheology modification, wetting agents, antibacterial agents, photoinitiators, other dyes or pigments, UV absorbing agents, processing aids and the like, and combinations thereof.

The photochromic composition of the invention becomes embedded in the lens material upon curing of the material. Thus, the photochromic composition may embed closer to the front or back surface of the lens formed depending on the surface of the mold to which the lens the photochromic composition is applied. Additionally, one or more layers of photochromic composition may be applied in any order. In yet another embodiment, a clear binding polymer layer may be used in conjunction with the photochromic composition. For example, in the method of the invention a clear binding polymer layer may be applied to the molding surface of a mold half prior to application of the photochromic composition. The clear binding polymer may be the same or different from the binding polymer used for the photochromic composition layers. If the clear binding polymer is different from the binding polymer, it must be compatible with the binding polymer and lens material in terms of expansion factor and swellability and it must be capable of swelling into the lens material.

The invention may be used to provide tinted hard or soft contact lenses made of any known lens material, or material suitable for manufacturing such lenses. Preferably, the lenses of the invention are soft contact lenses having water contents of about 0 to about 90 percent. More preferably, the lenses are made of monomers containing hydroxy groups, carboxyl groups, or both or be made from silicone-containing polymers, such as siloxanes, hydrogels, silicone hydrogels, and combinations thereof. Material useful for forming the lenses of the invention may be made by reacting blends of macromers, monomers, and combinations thereof along with additives such as polymerization initiators. Suitable materials include, without limitation, silicone hydrogels made from silicone macromers and hydrophilic monomers. Examples of such silicone macromers include, without limitation, polydimethylsiloxane methacrylated with pendant hydrophilic groups as described in U.S. Pat. Nos. 4,259,467; 4,260,725 and 4,261,875; polydimethylsiloxane macromers with polymerizable function described in U.S. Pat. Nos. 4,136,250; 4,153,641; 4,189,546; 4,182,822; 4,343,927; 4,254,248; 4,355,147; 4,276,402; 4,327,203; 4,341,889; 4,486,577; 4,605,712; 4,543,398; 4,661,575; 4,703,097; 4,837,289; 4,954,586; 4,954,587; 5,346,946; 5,358,995; 5,387,632; 5,451,617; 5,486,579; 5,962,548; 5,981,615; 5,981,675; and 6,039,913; and combinations thereof. They may also be made using polysiloxane macromers incorporating hydrophilic monomers such as those described in U.S. Pat. Nos. 5,010,141; 5,057,578; 5,314,960; 5,371,147 and 5,336,797; or macromers comprising polydimethylsiloxane blocks and polyether blocks such as those described in U.S. Pat. Nos. 4,871,785 and 5,034,461. All of the cited patents are hereby incorporated in their entireties by reference.

Suitable materials also may be made from combinations of oxyperm and ionoperm components such as is described in U.S. Pat. Nos. 5,760,100; 5,776,999; 5,789,461; 5,807,944; 5,965,631 and 5,958,440. Hydrophilic monomers may be incorporated into such copolymers, including 2-hydroxyethyl methacrylate (“HEMA”), 2-hydroxyethyl acrylate, N,N-dimethylacrylamide (“DMA”), N-vinylpyrrolidone, 2-vinyl-4,4′-dimethyl-2-oxazolin-5-one, methacrylic acid, and 2-hydroxyethyl methacrylamide. Additional siloxane monomers may be incorporated such as tris(trimethylsiloxy)silylpropyl methacrylate, or the siloxane monomers described in U.S. Pat. Nos. 5,998,498; 3,808,178; 4,139,513; 5,070,215; 5,710,302; 5,714,557 and 5,908,906. They may also include various toughening agents, UV blockers, and wetting agents. They can be made using diluents such as primary alcohols, or the secondary or tertiary alcohols described in U.S. Pat. No. 6,020,445. All of the cited patents are hereby incorporated in their entireties by reference.

The materials for making the contact lenses are well known and commercially available. In one non-limiting embodiment, the material used is a HEMA based hydrogel, more preferably etafilcon A, and the binding polymer is formed from linear random block copolymers of MAA, HEMA and lauryl methacrylate (“LMA”); linear random block copolymers of MAA and HEMA; linear random block copolymers of HEMA and LMA; or a HEMA homopolymer. Etafilcon A, disclosed in U.S. Pat. Nos. 4,680,336 and 4,495,313 incorporated herein in their entireties by reference, generally is a formulation of 100 parts by weight (“pbw”) HEMA, about 1.5 to about 2.5 pbw MAA, approximately 0.3 to about 1.3 pbw ethylene glycol dimethacrylate, about 0.05 to about 1.5 pbw 1,1,1,-trimethylolpropane trimethacrylate, and about 0.017 to about 0.024 pbw of a visibility tint. Preferably etafilcon A is used with a linear random block copolymer of MAA, HEMA and LMA in a ratio of 0.47 MAA to 100 HEMA to 4.14 LMA, or with a linear random block copolymer of HEMA and MAA in a ratio of 99.9 HEMA and 0.1 MAA to 99.5 HEMA and 0.5 MAA.

A photochromic amount of the photochromic composition is used. In one non-limiting embodiment, where the ophthalmic device is a soft contact lens, about 0.5 mg to about 4.0 mg of photochromic composition may be used per lens.

The photochromic composition used in the lenses of the invention are applied to the lens surface by any convenient method. In a preferred method of the invention, the photochromic composition is applied to a thermoplastic optical mold. The surface energy and chemical composition of the mold material is selected to allow application of the coating mixture to form a film, and then allow the coating mixture to release to the lenses after the lenses are formed. Any suitable material may be used, including, without limitation, polypropylene resin, polystyrene resin, cycloolefin-based polymers such as TOPAS, which is an amorphous copolymer based on cycloolefins and ethylene, commercially available from Ticona, polymers made by ring-opening metathesis polymerization of norbornene compounds followed by hydrogenation, such as Zeonor, which is commercially available from Zeon Corporation, glass, metal, or quartz. A tinting-effective amount of the photochromic composition is applied to the desired portion of the molding surface of the mold. The photochromic composition may be applied to the front or back mold surfaces or to both. It can be applied to either the entirety of the front or back of the lens, or to only a portion of the surface of the lens, for example, only covering the optic zone of the lens, or only covering the portion of the lens that covers the iris. Application may be carried out by any convenient means. Non-limiting examples include any of several methods known to those skilled in the art, including but not limited to spraying, pad printing, tampo printing, brushing or stamping. If a volatile solvent is incorporated into the coating mixture, it may be desired to allow this solvent to evaporate before filling the mold with lens material. If polymerizable polymers or monomers are used in the photochromic tinting composition it may be useful to expose the coated mold to conditions sufficient to cure the photochromic tinting composition before filling the mold, or it may be preferred to fill the mold without curing the photochromic tinting composition in order to allow the photochromic tinting composition and lens material to cure concurrently. Preferably, application is carried out by pad printing.

A lens-forming amount of a lens material is dispensed into the mold. By “lens-forming amount” is meant an amount sufficient to produce a lens of the size and thickness desired. Typically, about 10 to about 40 mg of lens material is used.

In one non-limiting embodiment, the photochromic composition is swelled in the lens material. Preferably, the swelling is carried out under conditions suitable to swell the photochromic composition to about 1 to about 4 times its dried thickness. Typically, such swelling may be achieved in from about 1 to about 30 minutes, and some embodiments between about 1 and about 10 minutes at about 40 to about 68° C.

The mold containing the lens material and photochromic composition then is exposed to conditions suitable to form the photochromic lens. The precise conditions will depend upon the components of the photochromic composition and lens material selected and are within the skill of one of ordinary skill in the art to determine. Once curing is completed, the lens is released from the mold and may be equilibrated in a buffered saline solution.

A preferred method of manufacturing a photochromic lens is carried out using pad printing as follows. A metal plate, preferably made from steel and more preferably from stainless steel, is covered with a photo resist material that is capable of becoming water insoluble once cured. The pattern for the photochromic composition is selected or designed and then reduced to the desired size using any of a number of techniques such as photographic techniques, placed over the metal plate, and the photo resist material is cured. Conditions for carrying out the pattern etching are within the knowledge of one ordinarily skilled in the art.

Following the pattern, the plate is subsequently washed with an aqueous solution and the resulting image is etched into the plate to a suitable depth, for example about 20 microns. The photochromic composition is then deposited onto the pattern to fill the depressions with photochromic composition. A silicon pad of a suitable geometry and varying hardness, generally about 1 to about 10 Shore A durometer units, is pressed against the image on the plate to remove the photochromic composition and the photochromic composition is then dried slightly by evaporation of the solvent. The pad is then pressed against the molding surface of an optical mold and the photochromic composition s allowed to dry. The mold is degassed for up to 12 hours to remove excess solvents and oxygen after which the mold is filled with lens forming amount of a lens material. A complementary mold half is then used to complete the mold assembly and, after the printed image is allowed to swell, the mold assembly is exposed to conditions suitable to cure the lens material used.

The invention will be clarified further by consideration of the following, non-limiting examples.

### EXAMPLES

The following abbreviations are used in the examples below.

| | |
|---|---|
| HEMA | 2-hydroxyethyl methacrylate |
| NORBLOC | 2-(2′-hydroxy-5-methacrylyloxyethylphenyl)- |
| | 2H-benzotriazole |
| Blue HEMA | the reaction product of Reactive Blue 4 and HEMA, as |
| | described in Example 4 of U.S. Pat. no. 5,944,853 |
| EGDMA | ethyleneglycol dimethacrylate |
| IRGACURE 1700 | 75% (wt) 2-hydroxy-2-methyl-1-phenylpropan-1-one |
| | and 25% bis(2,6-dimethoxybenzoyl)-2,4,4- |
| | trimethylpentyl phosphine oxide, commercially |
| | available from CIBA Specialty Chemicals |
| TMPTMA | trimethylolpropane trimethacrylate |
| MAA | methacrylic acid |

Synthesis for Photochromic Compound I
Step 1

3,9-Dimethoxy-5-hydroxy-7H-benzo[C]fluoren-7-one (10 g, made by methodology described in U.S. Pat. No. 6,296,785 B1), 1-(4-methoxyphenyl)-1-(3,4-dimethoxyphenyl)-2-propyn-1-ol (26 g, made by methodology described in U.S. Pat. No. 5,458,814), dodecylbenzene sulfonic acid (1 g) and chloroform (250 mL) were combined in a reaction flask and stirred at room temperature for 1 hours. The reaction mixture was then heated at reflux for 8 hours and cooled to room temperature. The reaction mixture was concentrated, and the residue was washed with cold acetone and vacuum-dried, yielding 19 g of an off-white solid.

Step 2

The product from Step 1 (11.0 g) was weighed into a reaction flask under a nitrogen atmosphere and 100 mL of anhydrous THF was added Methyl magnesium chloride (15 mL of 3.0 M in THF) was added to the reaction mixture over 15 minutes. The reaction mixture was stirred for 1 hour and then poured into 200 mL of a 1:1 mixture of ice and 1N HCl. The mixture was extracted with chloroform (three times with 100 mL). The organic extracts were combined, washed with saturated aqueous NaCl solution (200 mL) and dried over anhydrous Na₂SO₄. Removal of the solvent by rotary evaporation yielded a dark-blue residue, which was then precipitated from t-butyl methyl ether and filtered, providing 11 g of a blue-tinted solid.

Step 3

The product from Step 2 (7 g), diethyleneglycol (70 mL), p-toluenesulfonic acid (0.5 g) and toluene (70 mL) were combined in a reaction flask. The reaction mixture was heated at 55° C. for 2 hours and cooled to room temperature. The reaction mixture was poured into 200 mL of water and extracted with 100 mL of ethyl acetate. The organic layer was washed with saturated sodium bicarbonate and dried over anhydrous Na₂SO₄. The solution was concentrated and the dark-blue residue was purified by silica gel chromatography (ethyl acetate/hexanes: v/v-2/1), yielding 7.1 g of a blue foam.

Step 4

The product from Step 3 (4 g), 2-isocyanatoethylmethacrylate (2 mL), dibutyltin dilaurate (5 drops) and ethyl acetate (120 mL) were combined in a reaction flask with a condenser open to air. The mixture was heated at reflux for 2 hours. Methanol (5 mL) was added to the mixture to quench excess 2-isocyanatoethylmethacrylate. The reaction mixture was concentrated and the residue was purified by silica gel chromatography (ethyl acetate/hexanes: v/v-1/1). The major fraction was collected from the column and concentrated, yielding 5 g of a purple foam. Mass spectroscopy analysis supports the molecular weight of 3-(4-methoxyphenyl)-3-(3,4-dimethoxyphenyl)-6,11-dimethoxy-13-methyl-13-(2-(2-(2-methacryloxyethyl)carbamyloxyethoxy)ethoxy)-3H,13H-indeno[2′,3′:3,4]naphtho[1,2-b]pyran.

Synthesis for Photochromic Compound II

Step 1

4-Hydroxybenzophenone (100 g), 2-chloroethanol (50 g), sodium hydroxide (20 g) and water (500 mL) were combined in a reaction flask. The mixture was heated at reflux for 6 hours. The oily layer was separated and crystallized upon cooling, the crystalline material was washed with aqueous sodium hydroxide followed by fresh water and dried, yielding an off-white solid 85 g. The product was used without further purification in the subsequent reaction.

Step 2

The product from above Step 1 (30 g) was dissolved in anhydrous dimethylformamide (250 mL) in a reaction flask with overhead stirring. Sodium acetylide paste in toluene (15 g, ˜9 wt %) was added to the reaction flask under vigorous stirring. After the reaction is complete, the mixture was added to water (500 mL), and the solution was extracted with ethyl ether (twice with 500 mL). The extracts were combined and washed with saturated aqueous sodium chloride solution and dried over sodium sulfate. The solution was then filtered and concentrated, and the dark residue was purified by silica gel chromatography (ethyl acetate/hexanes (v/v): 1/1), and the major fraction was collected from column and precipitated in t-butyl methyl ether, yielding 33 g of a white solid.

Step 3

3,9-Dimethoxy-7,7-dimethyl-7H-benzo[C]fluoren-5-ol from above Step 2 (5 g, made by methodology described in U.S. Pat. No. 6,296,785 B1), 1-phenyl-1-(4-(2-hydroxyethoxy)phenyl)-2-propyn-1-ol from Step 3 (4 g), dodecylbenzene sulfonic acid (2 drops) and chloroform (40 mL) were combined in a reaction flask. The mixture was heated at reflux for an hour and then concentrated. The residue was purified by silica gel chromatography (ethyl acetate/hexanes (v/v):1/1). The major fraction was collected from the column and concentrated to 7 g of green foam. Mass spectroscopy analysis supports the molecular weight of 3-phenyl-3-(2-hydroxyethoxy)phenyl-6,11-dimethoxy-13,13-dimethyl-3H,13H-indeno[2′,3′:3,4]naphtho[1,2-b]pyran.

Step 4

3-Phenyl-3-(2-hydroxyethoxy)phenyl-6,11-dimethoxy-13,13-dimethyl-3H,13H-indeno[2′,3′:3,4]naphtho[1,2-b]pyran from above Step 3 (5 g), 2-isocyanatoethylmethacrylate (1 mL), dibutyltin dilaurate (1 drop) and ethyl acetate (20 mL) were combined in a reaction flask with a condenser open to air. The mixture was heated at reflux for 1 hour. Methanol (5 mL) was added to the mixture to quench excess 2-isocyanatoethylmethacrylate. The reaction mixture was concentrated and the residue was purified by silica gel chromatography (ethyl acetate/hexanes (v/v): 1/1), yielding 6.3 g of green foam. Mass spectroscopy analysis supports the molecular weight of 3-phenyl-3-(4-(2-(2-methacryloxyethyl)carbamyloxyethoxy)phenyl)-6,11-dimethoxy-13,13-dimethyl-3H,13H-indeno[2′,3′:3,4]naphtho[1,2-b]pyran.

### Example 1

Binding polymer was formed by the following process:

To the cold stirred reactor was added about 537 g 1-octanethiol, followed by 20,850 g 2-hydroxyethylmethacrylate, 283 g methacrylic acid, 29,415 g isopropyl lactate, 7,363 g 1-ethoxy-2-propanol, and 973 g glycerol. The reactor was heated to about 68° C., and 128 g parts 2,2′-azobis-(2-methylbutyronitrile) was added to start the polymerization process. After 3 hours most of the monomers had reacted, but the temperature was maintained overnight at 68° C. to finish the process. The reactor was heated to about 80° C. for about 24 hours more to destroy excess initiator. The reactor was cooled and the viscosity was adjusted to 5900 to 7700 mPas (23° C.) by adding about 1,000 g of a mixture of the above-mentioned solvents. The solution was filtered through a 5 micron filter to obtain the finished binding polymer having a Mₚₑₐₖ of about 28,000 g/mole.

Photochromic colorant, a dark green, slightly viscous solution containing a 96% (wt) binding polymer, 4% (wt) photochromic compound 1 and 0.3% hydroquinone monomethyl ether (MEHQ) was pad printed onto the front curve molding surface of a polystyrene optical mold The transfer of the photochromic colorant to the front curve mold surface was accomplished using a two layer process. The process utilized chiques designed at a specific depth to ensure adequate transfer of the material using silicon pads on to the front curve surface. The initial step in the pad printing of the front curve surface utilized an unpigmented layer of binding polymer transferred onto the lens mold surface. The second layer consisted of binding polymer with photochromic dye. The mold was filled with a lens-forming amount of the monomer mix made from 52 weight parts of a blend of 94.9% HEMA, 1.94% (wt) MAA, 0.77% EGDMA, 0.09% TMPTMA, 0.95% NORBLOC, 0.02% Blue HEMA and 1.33% IRGACURE 1700 with 48 parts boric acid ester of glycerin as diluent.

Precure of the reactive monomer slows its diffusion into the colorant. To maintain the benefits of precure, while avoiding a decrease in the diffusion rate of the monomer, a method of shielding the lens area from precure light was developed. This method utilizes a mask inside the precure weight that shields light from the lens area of the molds, while still exposing the outer perimeter for precure of the monomer mix beyond the lens. This excess monomer mix now becomes the chief area of increased monomer viscosity for providing stability to the mold assembly while the monomer for the lens remains uninhibited for rapid diffusion into the photochromic colorant. The pallet containing eight mold assemblies was placed into the preheat station, where short wave IR bulbs are located above the product. The mold assembly passed under the IR bulbs and was heated to the Tg of the photochromic colorant. Control of the energy output of the IR heating fixture was maintained by a variable auto transformer. The mold assembly then passed into a dark zone in which no bulbs were present, but in which heaters heated the air to between 55 and 75° C. to maintain the mold temperature at or above the photochromic colorant Tg. The mold passed through the IR bulb and dark zone of the curing tunnel at a speed so that it remained in this zone for a minimum of 75 seconds during which time the Tg temperature was maintained. This time is required to establish complete diffusion of the monomer into the photochromic dye layer. The mold then exited this zone and photochemical curing of the lens material was initiated and completed.

Once curing was completed, the mold assembly was opened and the lenses were released from the molds and hydrated by immersing them in water according to the conditions of Table 1.

TABLE 1
Lens batch hydration process

| Step | Temperature | Solution | Time |
|---|---|---|---|
| 1 | 70-80° C. | DI water with 800 ppm Tween 80 | 60 minutes |
| | | | Minimum |
| 2 | 45° C. | DI Water | 60 minutes |
| | | | Minimum |

Finished lenses were cross-sectioned and the exposed edges were examined microscopically to confirm the presence of a well-defined continuous clear layer and to measure the depth of the clear layer. The depth of the clear layer was found to be a minimum of 2 microns and a maximum of 28 micron.

The photochromic efficacy of the lenses was determined by the following method A lens is placed in a cuvette containing borate-buffered saline at 35° C. The absorbance of the lens is measured in a UV/Visible spectrometer while the lens is being irradiated with light from about 260 to 800 nm at an intensity that mimics direct sunlight.

### Example 2

The procedure of Example 1 was repeated except using photochromic dye II.

### Example 3

The procedure of Example 2 was repeated except using 9% (wt) photochromic dye II, and omitting the MEHQ in the coating mixture.

### Comparative Example 1

18% photochromic dye II was added to the binding polymer and mixed on a jar roller. The photochromic compound did not dissolve.

1. A photochromic composition for use in tinting contact lenses, the photochromic composition comprising one or more photochromic compound, one or more solvents, and a binding polymer, wherein the binding polymer is capable of forming an interpenetrating polymer network with a lens material.

2. The photochromic composition of claim 1, wherein the interpenetrating polymer network formed is a semi-interpenetrating polymer network.

3. The photochromic composition of claim 1, wherein the interpenetrating polymer network formed is a sequential-interpenetrating polymer network.

4. The photochromic composition of claim 1, wherein the binding polymer comprises a molecular weight, Mₚₑₐₖ, of about 7,000 to about 40,000.

5. The photochromic composition of claim 1, wherein the binding polymer comprises:
CH₃(CH₂)ₓ-L-COCHR═CH₂
wherein L is —NH or oxygen, x is a whole number from 2 to 24, R is a C₁ to C₆ alkyl or hydrogen.

6. The photochromic composition of claim 1, wherein the binding polymer comprises a copolymer of methacrylic acid, 2-hydroxyethyl methacrylate, and lauryl methacrylate.

7. The photochromic composition of claim 1, wherein the binding polymer comprises a copolymer of 2-hydroxyethyl methacrylate and methacrylic acid.

8. The photochromic composition of claim 1, wherein the binding polymer comprises a homopolymer of 2-hydroxyethyl methacrylate.

9. The photochromic composition of claim 1, 2, 3, 4, 6, 7 or 8, wherein the one or more solvents comprises at least one medium boiling point solvents and one low boiling point solvent.

10. The photochromic composition of claim 1, 2, 3, 4, 6, 7 or 8, wherein the surface tension is ≦28 dynes/cm.

11. The photochromic composition of claim 6, 7 or 8 wherein the medium boiling point solvents comprise 1-ethoxy-2-propanol and isopropyl lactate.

12. The photochromic composition of claim 1, 2, 3, 4, 6, 7 or 8, further comprising at least one additional component selected from the group consisting of plasticizers, pigments, opacifying agents and mixtures therof.

13. The photochromic composition of claim 12, comprising about 0.2 to about 25 weight percent of the one or more pigments, about 30 to about 45 weight percent of the binding polymer, about 40 to about 70 weight percent of the one or more solvents, about 0 to about 25 weight percent of the opacifying agent, and about 0.2 to about 7 weight percent of the plasticizer.

14. A photochromic composition for use in tinting contact lenses, the photochromic composition comprising one or more photochromic compound, one or more solvents, and a binding polymer having a molecular weight, Mₚₑₐₖ, of about 7,000 to about 40,000, wherein the binding polymer is capable of forming an interpenetrating polymer network with a lens material comprising a HEMA-based hydrogel or a silicone-based hydrogel.

15. The photochromic composition of claim 14, wherein the interpenetrating polymer network formed between the binding polymer and the lens material is a semi-interpenetrating polymer network

16. The photochromic composition of claim 14, wherein the interpenetrating polymer network formed between the binding polymer and the lens material is a sequential interpenetrating polymer network

17. The photochromic composition of claim 14, wherein the binding polymer comprises a copolymer of methacrylic acid, 2-hydroxyethyl methacrylate, and lauryl methacrylate.

18. The photochromic composition of claim 14, wherein the binding polymer comprises a copolymer of methacrylic acid and 2-hydroxyethyl methacrylate.

19. The photochromic composition of claim 14, wherein the binding polymer comprises a homopolymer of 2-hydroxyethyl methacrylate.

20. The photochromic composition of claims 14-19, wherein the one or more solvents comprises two medium boiling point solvents and one low boiling point solvent.

21. The photochromic composition of claim 20, wherein the two medium boiling point solvents comprise 1-ethoxy-2-propanol and isopropyl lactate.

22. The photochromic composition of claims 14-19 further comprising a plasticizer and at least one pigment.

23. The photochromic composition of claim 22, comprising about 0.2 to about 25 weight percent of the one or more pigments, about 30 to about 45 weight percent of the binding polymer, about 40 to about 70 weight percent of the one or more solvents, about, and about 0.2 to about 7 weight percent of the plasticizer.

24. A method for manufacturing a photochromic contact lens comprising the steps of: a.) applying to a molding surface of a mold a tinting-effective amount of a photochromic composition comprising one or more photochromic compounds, one or more solvents and at least one binding polymer; b.) dispensing a lens-forming amount of a lens material into the mold; c.) swelling the photochromic composition in the lens material; and d.) curing the lens material in the mold to form the tinted contact lens, wherein the binding polymer and the lens material form an interpenetrating polymer network.

25. The method of claim 24, wherein the binding polymer has a molecular weight, Mₚₑₐₖ, of about 7,000 to about 40,000 and the lens material comprises HEMA based hydrogels or silicone-based hydrogels.

26. The method of claim 24, wherein the binding polymer comprises a copolymer of methacrylic acid, 2-hydroxyethyl methacrylate, and lauryl methacrylate.

27. The method of claim 24, wherein the binding polymer comprises a copolymer of methacrylic acid and 2-hydroxyethyl methacrylate.

28. The method of claim 24, wherein the binding polymer comprises a homopolymer of 2-hydroxyethyl methacrylate.

29. The method of claim 24 or 25, wherein the one or more solvents comprises two medium boiling point solvents and one low boiling point solvent.

30. The method of claim 29, wherein the two medium boiling point solvents comprise 1-ethoxy-2-propanol and isopropyl lactate.

31. A mold for use in manufacturing a tinted contact lens comprising a first and second mold half, wherein at least one molding surface of the first and second mold halves comprises a layer on at least a part of said molding surface comprising, one or more photochromic compounds, one or more solvents, and a binding polymer, wherein the binding polymer is capable of forming an interpenetrating polymer network with a lens material.

32. The mold of claim 31, wherein the interpenetrating polymer network formed between the binding polymer and the lens material is a semi-interpenetrating polymer network.

33. The mold of claim 31, wherein the interpenetrating polymer network formed between the binding polymer and the lens material is a sequential interpenetrating polymer network.

34. The mold of claim 31, wherein the binding polymer has a molecular weight, Mₚₑₐₖ, of about 7,000 to about 40,000.

35. The mold of claim 31, wherein the binding polymer comprises a copolymer of methacrylic acid, 2-hydroxyethyl methacrylate, and lauryl methacrylate.

36. The mold of claim 31, wherein the binding polymer comprises a copolymer of methacrylic acid and 2-hydroxyethyl methacrylate.

37. The mold of claim 31, wherein the binding polymer comprises a homopolymer of 2-hydroxyethyl methacrylate.

38. The mold of claim 31-37 wherein the one or more solvents comprises two medium boiling point solvents and one low boiling point solvent.

39. The mold of claim 38, wherein the two medium boiling point solvents comprise 1-ethoxy-2-propanol and isopropyl lactate.

40. The ophthalmic lens derived from the photochromic composition of claim 23, the method of claim 30 and the mold of claim 39.

41. The method of claim 24 wherein said photochromic compound is coated or wetted with said binding polymer.
